(19) United States
(12) Patent Application Publication
(10) Pub. No.: US 2023/0060384 A1
(43) Pub. Date: Mar. 2, 2023

(54) HIGH FREQUENCY, HIGH CURRENT MANUFACTURING SYSTEM AND METHOD

(71) Applicant: Honeywell Federal Manufacturing & Technologies, LLC, Kansas City, MO (US)

(72) Inventor: Jacob Hafner, Overland Park, KS (US)

(73) Assignee: Honeywell Federal Manufacturing & Technologies, LLC, Kansas City, MO (US)

(21) Appl. No.: 17/463,700

(22) Filed: Sep. 1, 2021

(51) Int. Cl. B22F 10/20; H02M 7/06; B33Y 10/00; B33Y 30/00; B23K 11/00; B23K 11/24

(52) U.S. Cl. CPC B22F 10/20; H02M 7/06; B33Y 10/00; B33Y 30/00; B23K 11/0013; B23K 11/241; B23K 2101/24

(57) ABSTRACT

A system for manufacturing a part, the system comprising a power source, a rectifier, an electrical conduit, and a framework. The power source is configured to generate a high frequency, high current electrical signal. The rectifier is configured to convert the electrical signal to a direct current electrical signal. The electrical conduit is configured to carry the electrical signal. The framework is formed of electrically resistive metal having a relatively high melting point and is connected to the electrical conduit and at least partially encased in a powdered metal having a melting point lower than the melting point of the framework so that transmission of the electrical signal through the framework transitions at least some of the powdered metal into its molten state so that at least some of the molten metal cooled into its solidified state forms at least a portion of the part.

### GOVERNMENT INTERESTS

This invention was made with Government support under Contract No.: DE-NA-0002839 awarded by the United States Department of Energy/National Nuclear Security Administration. The Government has certain rights in the invention.

### BACKGROUND

Conventional additive manufacturing facilitates virtually unrestricted part design, but it does not lend itself well to mass production and thus is best suited for creating prototypes and low-volume specialized parts. This is partially due to the significant amount of time required to build a part regardless of its complexity. Conventional additive manufacturing also employs many operating variables, which increase the chance of errors and manufacturing defects.

### SUMMARY

Embodiments of the invention solve the above-mentioned problems and other problems and provide a distinct advance in the art of part manufacturing. More particularly, the invention provides a system and method for efficiently manufacturing complex parts.

An embodiment of the invention is a part manufacturing system broadly comprising a high frequency, high current power source; a rectifier; an electrical conduit; a cooler; a build container; and a framework. The system can be used to manufacture mechanical parts, electronic circuits, material matrices, and the like.

The high frequency, high current power source is configured to be electrically connected to the rectifier and the framework via the electrical conduit. In one embodiment, the high frequency, high current power source is an alternating current (AC) generator.

The rectifier is configured to be electrically connected to the high frequency, high current power source and converts AC current to pulsed DC current. To that end, the rectifier may be a diode or series of diodes.

The electrical conduit electrically connects the high frequency, high current power source, the rectifier, and the framework to form an electrical circuit. The electrical conduit may include electrical wiring, electrical connectors, electrodes, and the like.

The cooler is configured to cool molten metal. The cooler may be an air circulator, a heat sink, a coolant material, a coolant circulator, or the like.

The build container contains powdered metal in encasement around the framework. The build container may be a mold, a crucible, an oven, or other suitable enclosure configured to withstand high heat.

The framework is a sacrificial structure made of high melting point, electrically resistive metal such as tungsten and may be or may include wire components. The framework may include bends, coils, folds, creases, flat sections, extrusions, welds, solders, cuts, and the like. The framework is configured to be at least partially encased (i.e., surrounded, submerged, or enclosed) in a powdered metal in the build container and electrically connected to the high frequency, high current power source and the rectifier via the electrical conduit.

The powdered metal may have a melting point lower than the melting point of the framework. The powdered metal may be steel, aluminum, or any other suitable low melting point metal. When working with low magnetic or non-magnetic metals, embodiments allow for use of related magnetic alloys or powder mixes including more magnetic materials with the low magnetic or non-magnetic metals.

In use, the framework is formed and shaped according to a desired part. To that point, the framework may be bent, coiled, folded, creased, flattened, extruded, welded, soldered, cut, or the like. The framework is then electrically connected to the high frequency, high current power source and the rectifier via the electrical conduit. The framework is also encased in the powdered metal in the build container.

The high frequency, high current power source is then activated so that a high frequency, high current electrical signal, modified by the rectifier, passes through the framework. This causes the framework to heat up and/or create magnetic fields near the framework. Powdered metal near the framework transitions to a molten state due to heat generated by the magnetic fields and/or heat transferred from the framework. Meanwhile, powdered metal farther away from the framework is attracted to the framework via the magnetic fields.

The high frequency, high current power source is then deactivated to reduce or eliminate heating and reduce or eliminate the magnetic fields. Alternatively, the high frequency, high current power source may be set to a minimized level or may be kept activated at this stage.

The cooler is then activated to cool the powdered metal. In one embodiment, the cooler rapidly cools some of the outer-most molten metal (relative to the framework) to its solid state so that molten metal near the framework can cool and solidify naturally within confines of the rapidly-cooled outer-most metal.

Once the molten metal or the desired portions of the molten metal has solidified to form the part, the part is then disconnected from the electrical conduit and removed from the powdered metal and the build container.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of a part manufacturing system constructed in accordance with an embodiment of the invention;

FIG. 2 is an enlarged plan view of portions of the system of FIG. 1;

FIG. 3 is an enlarged plan view of portions of the system of FIG. 1;

FIG. 4 is an enlarged plan view of portions of the system of FIG. 1; and

FIG. 5 is a flow diagram showing certain method steps of forming a part via the system of FIG. 1.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

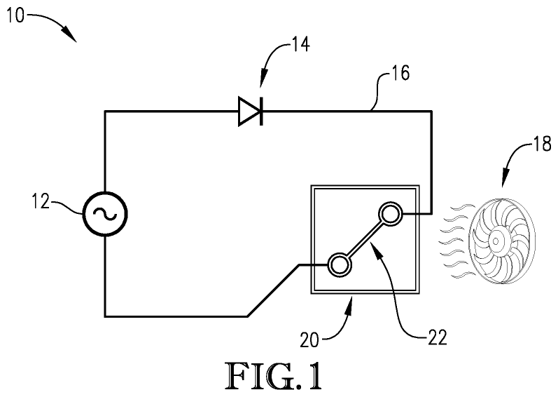

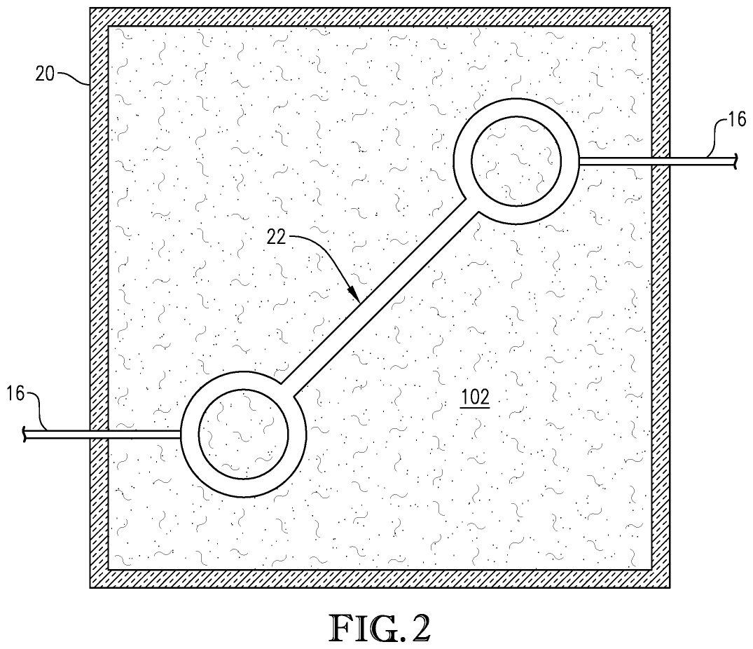

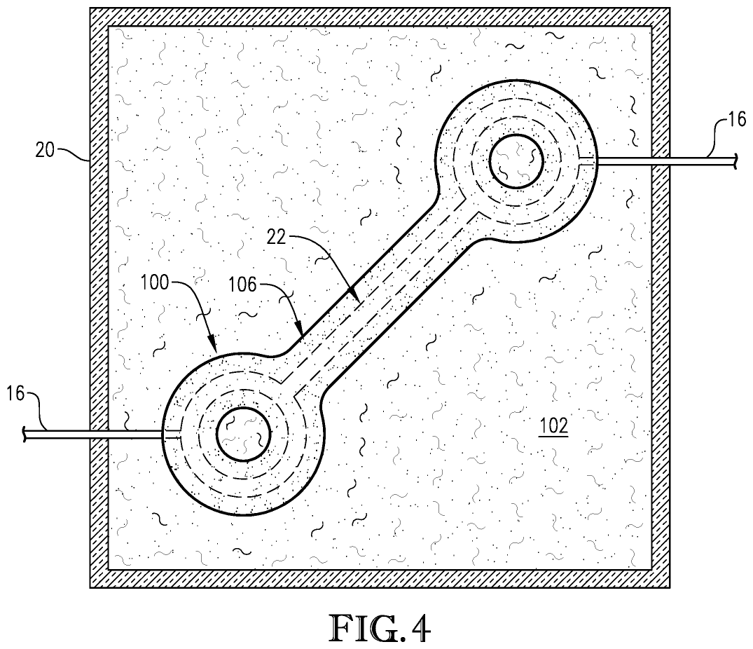

Turning to FIGS. 1-4, a system 10 for manufacturing a part in accordance with an embodiment of the invention is illustrated. The system 10 broadly comprises a high frequency, high current power source 12, a rectifier 14, an electrical conduit 16, a cooler 18, a build container 20, and a framework 22. The system 10 is shown in the creation of a mechanical part 100. Other components such as electronic circuits, material matrices, and the like may be manufactured via the system 10. The system 10 can be used for prototyping, production, optimization, experimentation, and other applications.

The high frequency, high current power source 12 is configured to be electrically connected to the rectifier 14 and the framework 22 via the electrical conduit 16. The high frequency, high current power source 12 may be an alternating current (AC) generator, a supercapacitor, a battery, line supply, or the like. Alternatively, the high frequency, high current power source 12 may include a direct current (DC) power supply coupled with an inverter, or other power source configurations.

The rectifier 14 is configured to be electrically connected to the high frequency, high current power source 12 and converts AC current to DC current. To that end, the rectifier 14 may be a diode or series of diodes. In one embodiment, the rectifier 14 is a half wave rectifier configured to convert negative half cycles of an AC waveform to nil, thus resulting in pulsed DC current. The rectifier 14 may be further electrically connected to other electrical components such as capacitors to further smooth the current waveform.

The electrical conduit 16 electrically connects the high frequency, high current power source 12, the rectifier 14, and the framework 22 to form an electrical circuit. The electrical conduit 16 may including electrical wiring, electrical connectors, electrodes, and the like. The electrical conduit 16 should be electrically insulated and therefore highly electrically isolated to effect a controlled electrical signal and for safety.

The cooler 18 is configured to cool molten metal (described below). The cooler 18 may be an air circulator, a heat sink, a coolant material, a coolant circulator, or the like. In one embodiment, the cooler 18 is configured to rapidly cool the molten metal.

The build container 20 contains powdered metal (described below) in encasement around the framework 22. The build container 20 may be a mold, a crucible, an oven, or other suitable enclosure configured to withstand high heat. The build container 20 may also be electrically isolated and/or non-conductive. To that end, the build container 20 may be ceramic or high melting point metal.

The framework 22 may be a sacrificial structure made of high melting point, electrically resistive metal. The framework 22 may be or may include wire components. The framework 22 may be shaped or constructed to have a raw form of the part. To that end, the framework 22 may include bends, coils, folds, creases, flat sections, extrusions, welds, solders, cuts, and the like. The framework 22 may be made of tungsten or other similar high melting point, electrically resistive metal.

The framework 22 is configured to be at least partially encased (i.e., surrounded, submerged, or enclosed) in a powdered metal 102. The powdered metal 102 may have a melting point lower, and in some embodiments significantly lower, than the melting point of the framework 22. The powdered metal 102 may be steel, aluminum, or any other suitable low melting point metal. When working with low magnetic or non-magnetic metals, embodiments allow for use of related magnetic alloys or powder mixes including more magnetic materials with the low magnetic or non-magnetic metals. The powdered metal 102 may have selectively varying particle sizes or metal composition to effect melting or cooling gradients during processing or to effect property gradients in the part 100.

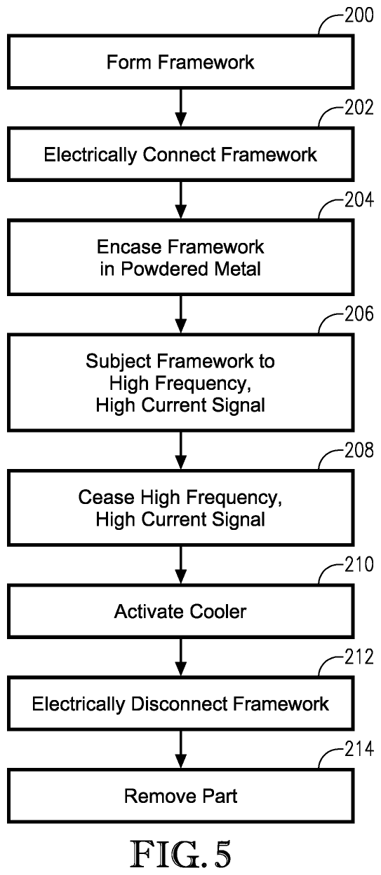

Turning to FIG. 5 and with reference to FIGS. 1-4, a method of making the part 100 via system 10 will now be described in detail. First, the framework 22 may be formed, as shown in block 200. To that point, the framework 22 may be bent, coiled, folded, creased, flattened, extruded, welded, soldered, cut, or the like.

The framework 22 may then be electrically connected to the high frequency, high current power source 12 and the rectifier 14 via the electrical conduit 16, as shown in block 202. For example, two electrodes may be attached to opposite ends of the framework 22.

The framework 22 may then be encased in the powdered metal 102, as shown in block 204. To ensure thorough and even submersion, the framework 22 and powdered metal 102 may be shaken or vibrated, or the powdered metal 102 may be poured over the framework 22. The framework 22 and powdered metal 102 may be positioned in the build container 20 to contain the powdered metal 102 around the framework 22. The build container 20 may also ensure the framework 22 and powdered metal 102 are completely electrically isolated except for the electrical connection via the electrical conduit 16. The build container 20 may further retain heat in the framework 22 and powdered metal 102 during heating.

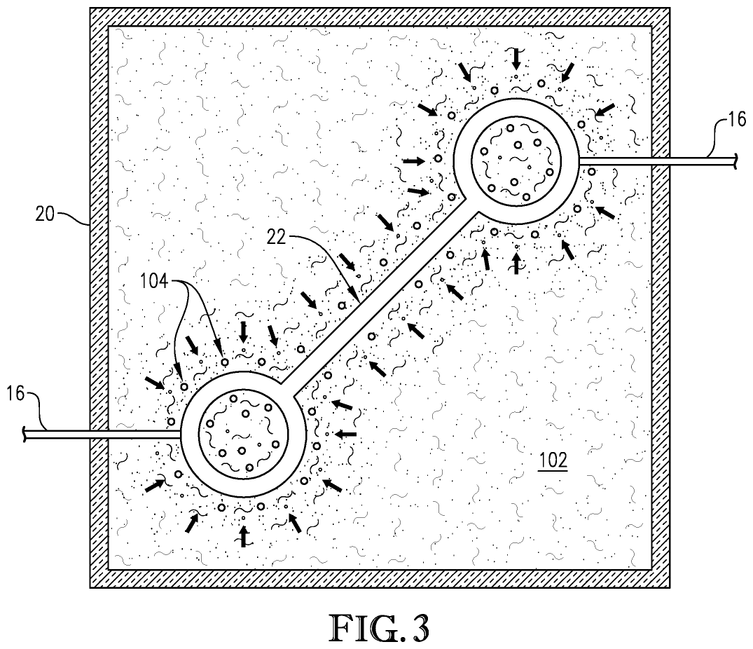

The high frequency, high current power source 12 may then be activated so that a high frequency, high current electrical signal, modified by the rectifier 14, passes through the framework 22, as shown in block 206. This may cause the framework 22 to heat up and/or create magnetic fields near the framework 22. Powdered metal 102 near the framework 22 or adjacent to the framework 22 may then transition to a molten state (molten metal 104) due to heat generated by the magnetic fields and/or heat transferred from the framework 22, as shown in FIG. 3. Powdered metal 102 farther away from the framework 22 may be attracted to the framework 22 via the magnetic fields.

The high frequency, high current power source 12 may then be deactivated to reduce or eliminate heating and reduce or eliminate the magnetic fields, as shown in block 208. Alternatively, the high frequency, high current power source 12 may be turned to a minimized level or may be kept activated at this stage.

The cooler 18 may then be activated to begin cooling the powdered metal 102, as shown in block 210. In one embodiment, the cooler 18 may rapidly cool some of the outer-most molten metal (relative to the framework 22) to its solid state so that molten metal near the framework 22 can cool and solidify naturally within confines of the rapidly-cooled outer-most metal.

Once the molten metal or the desired portions of the molten metal has solidified (solidified metal 106) to form the part 100, the part 100 may then be disconnected from the electrical conduit 16, as shown in block 212. The part 100 may also be removed from the powdered metal 102 and the build container 20, as shown in block 214.

The above-described system 10 and method provides several advantages. For example, frameworks can be built quickly, thus facilitating mass production setup. Parts can be produced quicker compared to conventional additive manufacturing techniques. Furthermore, the chance for error is minimized compared to conventional additive manufacturing techniques due to fewer operation variables.

The system 10 and method can be easily tailored by incorporating different or additional framework materials, powdered metal metals and supplemental materials, and process conditions including temperatures, temperature gradients, heating and cooling rate changes and durations, electrical signal frequencies, waveforms, current magnitudes, magnetic fields sizes and shapes, and particle sizes. The system 10 and method also may simplify part design by eliminating the considerations required for layer-by-layer material deposition.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for manufacturing a part, the system comprising:
a power source configured to generate a high frequency, high current electrical signal;
an electrical conduit connected to the power source and configured to transfer the high frequency, high current electrical signal; and
a framework formed of electrically resistive metal having a relatively high melting point, the framework being connected to the electrical conduit and at least partially encased in a powdered metal having a melting point lower than the melting point of the framework so that transmission of the high frequency, high current electrical signal through the framework via the electrical conduit transitions at least some of the powdered metal into its molten state so that at least some of the molten metal cooled into its solidified state forms at least a portion of the part.

2. The system of claim 1, further comprising a half wave rectifier configured to convert the high frequency, high current electrical signal into a direct current signal.

3. The system of claim 1, some of the molten metal being near the framework and some of the molten metal being outer-most molten metal, the system further comprising a cooler configured to rapidly cool the outer-most molten metal to its solid state so that the molten metal near the framework can cool and solidify naturally within confines of the rapidly-cooled outer-most metal.

4. The system of claim 1, further comprising an electrically non-conductive container configured to contain the powdered metal in encasement around the framework.

5. The system of claim 1, wherein the framework is made of tungsten.

6. The system of claim 1, wherein the powdered metal is made of steel.

7. The system of claim 1, wherein the framework is a wire frame.

8. A method of manufacturing a part, the method comprising steps of:
generating a high frequency, high current electrical signal via a power source;
passing the high frequency, high current electrical signal through a framework formed of electrically resistive metal having a relatively high melting point via an electrical conduit connected to the power source so that the high frequency, high current electrical signal transitions at least some of a powdered metal into its molten state; and
cooling at least some of the molten metal to its solidified state so that the solidified metal forms at least a portion of the part.

9. The method of claim 8, further comprising a step of converting the high frequency, high current electrical signal to a direct current signal via a half wave rectifier.

10. The method of claim 8, some of the molten metal being near the framework and some of the molten metal being outer-most molten metal, the cooling step comprising rapidly cooling the outer-most molten metal to its solid state so that the molten metal near the framework can cool and solidify naturally within confines of the rapidly-cooled outer-most metal.

11. The method of claim 8, further comprising a step containing the powdered metal in encasement around the framework via an electrically non-conductive container.

12. The method of claim 8, further comprising a step of constructing the framework.

13. The method of claim 12, the step of constructing the framework including shaping wire into a desired form.

14. The method of claim 8, the step of passing the high frequency, high current electrical signal through the framework includes attracting some of the powdered metal toward the framework.

15. A method of manufacturing a part, the method comprising steps of:
creating a wire framework of electrically resistive metal having a high melting point;
electrically connecting the wire framework to a power source via an electrical conduit;
encasing the wire framework in powdered metal;
containing the powdered metal in encasement around the framework via an electrically non-conductive container;
electrically isolating the power source, electrical conduit, wire framework, and powdered metal;
generating a high frequency, high current electrical signal via the power source;
passing the high frequency, high current electrical signal through the framework so that the high frequency, high current electrical signal transitions at least some of a powdered metal into its molten state; and
cooling at least some of the molten metal to its solidified state so that the solidified metal forms at least a portion of the part.

16. The method of claim 15, further comprising a step of converting the high frequency, high current electrical signal to a direct current signal via a half wave rectifier.

17. The method of claim 15, some of the molten metal being near the wire framework and some of the molten metal being outer-most molten metal, the cooling step comprising rapidly cooling the outer-most molten metal to its solid state so that the molten metal near the framework can cool and solidify naturally within confines of the rapidly-cooled outer-most metal.

18. The method of claim 15, the step of passing the high frequency, high current electrical signal through the wire framework includes attracting some of the powdered metal toward the wire framework.

19. The method of claim 15, the step of encasing the wire framework in powdered metal including mixing an additional material with the powdered metal.

20. The method of claim 15, the step of encasing the wire framework in powdered metal including encasing different portions of the wire framework in powdered metal of different particle size.
